(19) United States
(12) Patent Application Publication
(10) Pub. No.: US 2018/0184661 A1
(43) Pub. Date: Jul. 5, 2018

(54) Improved Herbicidal Composition, Method and Use

(71) Applicant: Arysta LifeScience Benelux Sprl, Ougrée (BE)

(72) Inventor: Alan Pirotte, Houffalize (BE)

(21) Appl. No.: 15/737,450

(22) PCT Filed: May 25, 2016
(86) PCT No.: PCT/EP2016/061749

§ 371 Date: Dec. 18, 2017

(30) Foreign Application Priority Data
Jun. 25, 2015 (BE) BE2015/05388

(51) Int. Cl. A01N 47/30; A01N 33/22; A01N 25/02

(52) U.S. Cl. CPC A01N 47/30; A01N 25/02; A01N 33/22

(57) ABSTRACT

The invention provides a pre-emergence herbicidal composition for controlling broadleaf weeds and/or annual grasses in agricultural crops comprising a herbicidally effective amount of (a) diuron and (b) oxyfluorfen and an agriculturally acceptable adjuvant and/or carrier. Also provided is a method of controlling weeds and/or grasses in agricultural crops which comprises contacting the vegetation or the locus thereof with or applying to the soil to prevent the emergence of weeds or grasses a herbicidally effective amount of a herbicidal composition according to an embodiment of the invention. The invention also provides in a use of a combination of diuron and oxyfluorfen as herbicidal active ingredients for the pre-emergence control of selected weeds and grasses in agricultural crops. Particularly preferred are a method and uses wherein the applicative dose of diuron is within the range of 400-950 g per hectare and the applicative dose of oxyfluorfen is within the range of 40-95 g per hectare.

### TECHNICAL FIELD

The present invention relates to mixtures of herbicidal compounds and their compositions, and method using the mixtures and compositions for undesirable vegetation. The present invention provides formulations with a high efficacy and reduced environmental impact. The invention is advantageous to the field of agriculture, in particular to farmers looking for broader and improved weed spectrum and alternatives to high dose diuron treatments for pre-emergence weed control.

### BACKGROUND

The protection of crops from weeds and other vegetation which inhibit crop growth is a constantly recurring problem in agriculture.

The control of undesired vegetation is extremely important in achieving high crop efficiency. Achievement of selective control of the growth of weeds especially in such useful crops as citrus, among others, is very desirable. Uncontrolled weed growth in such useful crops can cause significant reduction in productivity and thereby result in increased costs to the farmer and the consumer. Many products are commercially available for these purposes, but the need continues for new products that are more effective, less costly, less toxic, and environmentally safer or have different modes of action.

To manage the weed infestation, researchers in the field of synthetic chemistry have produced an extensive variety of chemicals and chemical formulations effective in the control of such unwanted growth. Chemical herbicides of many types have been disclosed in the literature and a large number are in commercial use.

One of these chemical herbicides was diuron. Diuron (N′-(3,4-dichlorophenyl)-N,N-dimethylurea), disclosed in U.S. Pat. No. 2,655,445, became well-known as a herbicide providing control of undesired vegetation (i.e. weeds) in many crops, including asparagus, pineapple, banana, sugarcane, cotton, cranberry, peppermint, alfalfa and other forage legumes, cereals, maize (corn), sorghum, perennial grass-seed crops, olives, citrus, pome fruits, stone fruits and vines. Diuron was also used as an effective herbicide to control weeds in areas other than crops, such as on industrial sites, on railroad and other transportation rights-of-way, around farm buildings, and on the banks of irrigation and drainage ditches.

Although diuron was often applied as a directed application to avoid contact with the foliage of crops, because of diuron's greater activity against germinating rather than established plants, diuron could be satisfactorily applied under some circumstances over the top on established alfalfa, birdsfoot trefoil, asparagus, grass seed crops, oats, red clover, sugarcane, wheat and pineapple.

However, because diuron's herbicidal effect was strongest against germinating plants, obtaining satisfactory control of established weeds with post-emergence applications of diuron was more difficult to achieve than pre-emergence control of germinating weeds.

Europe reviewed the existing active ingredients in the framework of Directive 91/414/EEC. At the outcome of the evaluation, diuron was not included as substance in Annex I to the Directive, as on the basis of available information it had not been demonstrated that the risk to operators, groundwater, birds and mammals was acceptable. In accordance with Article 6(2) of Directive 91/414/EC, the European Diuron Task Force presented a request to Denmark, the original Rapporteur Member State, for a new application aiming at Annex I inclusion of the substance. Denmark finalized in November 2007 its examination and included a recommendation as to include diuron in Annex I for uses in strip application. Diuron was include in Annex I of the Directive with an entry into force on Oct. 1, 2008; in order to ensure that in all Member States the authorizations of plant protection products containing this active ingredient can be granted in accordance with the provisions of that Directive. There remains a continued need for a.i. producers to research ways to reduce the dose of diuron, while maintaining acceptable herbicidal efficacy. There is a clear interest in keeping diuron available as active ingredient, as it provides a chemical class of compounds and mechanism that is different to other herbicidal compounds used as herbicides. This helps to avoid the development of herbicide resistance.

The use of diuron previously was at 2 kg active ingredient per hectare. The revision that has led to the renewed inclusion of diuron on Annex I is 0.5 kg active ingredient per hectare, applied in strip i.e. 1.5 kg a.i./ha in the treated area. This means that diuron is only applied in band/strip applications, with the treated strip representing on average 1/3 of the crop area.

In view of the importance of weed control and the maintained availability of diuron as active ingredient, there is a continued need for further improvements.

It is the aim of the present invention to provide an alternative to the presently allowed solo use of diuron at 1.5 kg a.i. per hectare for weed control. In particular, the invention aims to realize further dose reductions while maintaining weed control efficacy. The alternative should be safe to workers and applicators, acceptable from an environmental and human risk assessment point of view and economically realistic.

### SUMMARY OF THE INVENTION

The invention provides broader and improved weed control and/or alternatives to high dose diuron applications for controlling undesired vegetation. The present invention is based on the finding that diuron and oxyfluorfen, already known individually for their herbicidal efficacy, provide improvements when applied in combination.

In a first aspect the invention provides a herbicidal composition for controlling weeds and/or grasses in agricultural crops comprising a herbicidally effective amount of (a) diuron and (b) oxyfluorfen and an agriculturally acceptable adjuvant and/or carrier. The species spectra of diuron and oxyfluorfen, i.e., the weed species which the respective compounds control, are broad and highly complementary.

In a preferred embodiment, the herbicidal composition is in the form of a suspension concentrate (SC). Suspension concentrates are easy dose, generate no dust, and are ready for use after mixing with water.

In a preferred embodiment, the weight ratio of diuron to oxyfluorfen is between 15:1 and 3:1, preferably 10:1. This ratio has been found particularly effective.

In a preferred embodiment, the composition comprises 400-950 g/L diuron and 40-95 g/L oxyfluorfen. Preferably the herbicidal composition comprises 500+50, 600+60 or 900+90 g diuron and oxyfluorfen per liter of formulated product.

In a most preferred embodiment, the herbicidal composition comprises a synergistically effective amount of (a) diuron and (b) oxyfluorfen. These combinations are particularly advantageous as they allow further reductions in dose rates.

In a second aspect, the invention provides a method of controlling weeds and/or grasses in agricultural crops which comprises applying to the soil to prevent the emergence of weeds or grasses a herbicidally effective amount of a herbicidal composition according to an embodiment of the invention.

In a preferred embodiment of a method of the invention, the agricultural crops are perennial tree crops or vine crops at least four years of age. Tree crops and vine crops of this age have deeper positioned roots than younger plants. This has for advantage that the herbicidal composition, which mainly remains present in the upper soil layers, is not phytotoxic to the roots of the tree or vine crops. This embodiment provides for herbicidal position selectivity.

In a preferred embodiment of a method of the invention, the herbicidal composition is applied at an application rate of 440 g/ha to 1500 g/ha based on the total amount of active ingredients diuron and oxyfluorfen in the composition. These dose rates provide a reduced use in the amount of diuron compared to what was previously feasible with diuron, while efficacy is maintained.

In a preferred embodiment of a method of the invention, the applicative dose of diuron is within the range of 400-950 g per hectare and the applicative dose of oxyfluorfen is within the range of 40-95 g per hectare. This application rate corresponds to the application of 11 of formulated product with 400+40 g to 950+95 g/l diuron and oxyfluorfen as active ingredients. This dose rate has the advantage that effective herbicide treatment can be provided at reduced dose rates. Such compositions provide for a partial replacement of diuron while efficacy of previously used compositions at 1500 g a.i./ha diuron as single active ingredient, can be maintained.

In a preferred embodiment of a method of the invention, per hectare one third of the area is treated. Herbicidal treatment is limited to the areas under the tree. The area between rows of trees is left untreated.

In a preferred embodiment of a method of the invention, the components of the mixture are applied either separately or as part of a multipart herbicidal system, which can be provided as a premix or a tank mix. Preferably a formulation wherein the active ingredients consist of diuron and oxyfluorfen is used.

In a third aspect, the invention provides in a use of a combination of diuron and oxyfluorfen as herbicidal active ingredients for the pre-emergence control of weeds in agricultural crops; wherein the weeds are selected from Convolvulus arvensis, Sonchus tennerimus, Malva sylvestris, Anagalis arvensis, Anthemis arvensis, Diplotaxis erucoïdes, Papaver rhoeas, Chenopodium album, Fumaria officinalis, Conyza bonariensis, Erigeron canadensis, Amaranthus species, Senecio vulgaris, Lamium amplexicaule, Heliotropium europaeum, Urtica urens, Rumex spinosus, Calendula arvensis, Portulaca oleracea, Sorghum halepense, Cyperus rotundus, Lolium multiflorum, Poa annua, and combinations thereof.

In a preferred embodiment of a use according to the invention, the agricultural crop is selected from olive trees, citrus trees, vines and pome fruit trees. In a preferred embodiment, the pome fruit tree is an apple tree or a pear tree.

In a preferred embodiment of a use according to the invention, the applicative dose of diuron is within the range of 400-950 g per hectare and the applicative dose of oxyfluorfen is within the range of 40-95 g per hectare. This use provides a dose reduction of diuron with maintenance of the weed control/efficacy a farmer is accustomed to from use of diuron alone. This ability to provide a partial replacement for diuron with another active ingredient in particular oxyfluorfen has the advantage in one hand to minimize risk to the environment and on the other hand to limit the risk of weed resistance development by using two active ingredients with different mode of action.

In a preferred embodiment of a use according to the invention, the pre-emergence control provides at least 85% control compared to an untreated check. This level of control is perceived by a farmer as effective. The % control can be assessed by comparison of the biomass produced weed growth on a treated plot versus an untreated plot. The percentage control can be expressed as % reduction. I 85: dose for 85% of weed control and biomass reduction.

### DESCRIPTION OF DRAWINGS

FIG. 1 is a bar graph representation of the efficacy trials (n=6) and results obtained on the perennial broadleaf weed Convolvulus arvensis in Spain. The weed was present in vine, olive and citrus crops.

FIG. 2 is a bar graph representation of the efficacy trials (n=3) and results obtained on Sonchus tenerrimus in Spain. The weed was present in vine, olive and citrus crops.

FIG. 3 is a bar graph representation of the efficacy trials (n=6) and results obtained on 15 annual and biennial broadleaf weeds in Spain. The weeds were present in vine, olive and citrus crops.

### DETAILED DESCRIPTION OF THE INVENTION

Unless otherwise defined, all terms used in disclosing the invention, including technical and scientific terms, have the meaning as commonly understood by one of ordinary skill in the art to which this invention belongs. By means of further guidance, term definitions are included to better appreciate the teaching of the present invention.

The recitation of numerical ranges by endpoints includes all numbers and fractions subsumed within that range, as well as the recited endpoints.

Diuron (formula I) is commercially available in herbicidal compositions sold by a variety of companies including DuPont (e.g. Karmex® Herbicide). Although diuron is most conveniently obtained as a commercial product, it can be prepared by methods described in U.S. Pat. No. 2,655,445. Diuron is classified as a substituted urea. It works through photosynthesis inhibition.

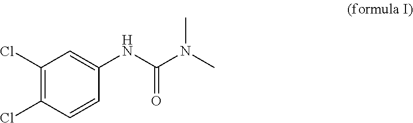

As used herein, and unless otherwise indicated, oxyfluorfen (formula II) is 2-chloro-1-(3-ethoxy-4-nitrophenoxy)-4-(trifluoromethyl)benzene and possesses the following structure:

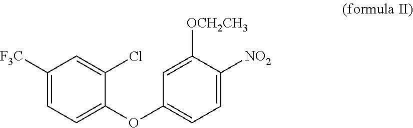 [SMILES: CCOc1cc(Oc2ccc(C(F)(F)F)cc2Cl)ccc1[N+](=O)[O-]]

Its herbicidal activity is exemplified in Tomlin, C. D. S., Ed. The Pesticide Manual: A World Compendium, 15 th ed.; BCPC: Alton, 2009 (hereafter “Z3/4e Pesticide Manual, Fifteenth Edition, 2009”). Exemplary uses of oxyfluorfen include pre- or post-emergence control of annual broadleaf weeds and grasses in temperate, tropical and subtropical crops.

The term herbicide is used herein to mean an active ingredient that kills, controls or otherwise adversely modifies the growth of plants. An herbicidally effective or vegetation controlling amount is an amount of active ingredient which causes an adverse modifying effect and includes deviations from natural development, killing, regulation, desiccation, retardation, and the like. The to s plants and vegetation include germinating seeds, emerging seedlings, plants emerging from vegetative propagules, and established vegetation.

Herbicidal activity is exhibited by the compounds of the mixture when they are applied directly to the plant or to the locus of the plant at any stage of growth or before planting or emergence. The effect observed depends upon the plant species to be controlled, the stage of growth of the plant, the application parameters of dilution and spray drop size, the particle size of solid components, the environmental conditions at the time of use, the specific compound employed, the specific adjuvants and carriers employed, the soil type, and the like, as well as the amount of chemical applied. These and other factors can be adjusted as is known in the art to promote non-selective or selective herbicidal action.

Generally, it is preferred to apply the composition of the present invention pre-emergence prior to germination and emergence, to achieve the maximum control of weeds. Preferably the pre-emergence residual herbicidal composition is applied on bare soil free of weeds and trash.

In the composition of this invention, the weight ratio of diuron to oxyfluorfen at which the herbicidal effect is synergistic lies within the range of between 15:1 and 3:1, preferably around 10:1.

In practice, it is preferable to use the composition of the present invention in mixtures containing an herbicidally effective amount of the herbicidal components along with at least one agriculturally acceptable adjuvant or carrier.

Suitable adjuvants or carriers should not be phytotoxic to valuable crops, particularly at the concentrations employed in applying the compositions for weed control in the presence of crops, and should not react chemically with herbicidal components or other composition ingredients. Such mixtures can be designed for application directly to weeds or their locus or can be concentrates or formulations that are normally diluted with additional carriers and adjuvants before application. They can be solids, such as, for example, dusts, granules, water dispersible granules, or wettable powders, or liquids, such as, for example, emulsifiable concentrates, solutions, emulsions or suspensions. Suitable agricultural adjuvants and carriers that are useful in preparing the herbicidal mixtures of the invention are well known to those skilled in the art. Some of these adjuvants include, but are not limited to, crop oil concentrate (mineral oil (85%)+emulsifiers (15%)); nonylphenol ethoxylate; benzylcocoalkyldimethyl quaternary ammonium salt; blend of petroleum hydrocarbon, alkyl esters, organic acid, and anionic surfactant; C9-C11 alkylpolyglycoside; phosphated alcohol ethoxylate; natural primary alcohol (Ci2-Ci6) ethoxylate; di-sec-butylphenol EO-PO block copolymer; polysiloxane-methyl cap; nonylphenol ethoxylate+urea ammonium nitrate; emulsified methylated seed oil; tridecyl alcohol (synthetic) ethoxylate (8EO); tallow amine ethoxylate (15 EO) and PEG(400) dioleate-99.

Liquid carriers that can be employed include water and organic solvents. The organic solvents typically used include, but are not limited to, petroleum fractions or hydrocarbons such as mineral oil, aromatic solvents, paraffinic oils, and the like; vegetable oils such as soybean oil, rapeseed oil, olive oil, castor oil, sunflower seed oil, coconut oil, corn oil, cottonseed oil, linseed oil, palm oil, peanut oil, safflower oil, sesame oil, tung oil and the like; esters of the above vegetable oils; esters of monoalcohols or dihydric, trihydric, or other lower polyalcohols (4-6 hydroxy containing), such as 2-ethyl hexyl stearate, n-butyl oleate, isopropyl myristate, propylene glycol dioleate, di-octyl succinate, di-butyl adipate, di-octyl phthalate and the like; esters of mono, di and polycarboxylic acids and the like. Specific organic solvents include toluene, xylene, petroleum naphtha, crop oil, acetone, methyl ethyl ketone, cyclohexanone, trichloroethylene, perchloroethylene, ethyl acetate, amyl acetate, butyl acetate, propylene glycol monomethyl ether and diethylene glycol monomethyl ether, methyl alcohol, ethyl alcohol, isopropyl alcohol, amyl alcohol, ethylene glycol, propylene glycol, glycerine, N-methyl-2-pyrrolidinone, N,N-dimethyl alkylamides, dimethyl sulfoxide, liquid fertilizers and the like. Water is generally the carrier of choice for the dilution of concentrates.

Suitable solid carriers include talc, pyrophyllite clay, silica, attapulgus clay, kaolin clay, kieselguhr, chalk, diatomaceous earth, lime, calcium carbonate, bentonite clay, Fuller's earth, cottonseed hulls, wheat flour, soybean flour, pumice, wood flour, walnut shell flour, lignin, and the like.

It is usually desirable to incorporate one or more surface-active agents into the compositions of the present invention. Such surface-active agents are advantageously employed in both solid and liquid compositions, especially those designed to be diluted with carrier before application. The surface-active agents can be anionic, cationic or nonionic in character and can be employed as emulsifying agents, wetting agents, suspending agents, or for other purposes. Surfactants conventionally used in the art of formulation and which may also be used in the present formulations are described, inter alia, in “McCutcheon's

Detergents and Emulsifiers Annual,” MC Publishing Corp., Ridgewood, N.J., 1998 and in “Encyclopedia of Surfactants,” Vol. I-III, Chemical Publishing Co., New York, 1980-81. Typical surface-active agents include salts of alkyl sulfates, such as diethanolammonium lauryl sulfate; alkylarylsulfonate salts, such as calcium dodecylbenzenesulfonate; alkylphenol-alkylene oxide addition products, such as nonylphenol-Cig ethoxylate; alcohol-alkylene oxide addition products, such as tridecyl alcohol-Ci6 ethoxylate; soaps, such as sodium stearate; alkylnaphthalene-sulfonate salts, such as sodium dibutyl-naphthalenesulfonate; dialkyl esters of sulfosuccinate salts, such as sodium di(2-ethylhexyl) sulfosuccinate; sorbitol esters, such as sorbitol oleate; quaternary amines, such as lauryl trimethylammonium chloride; polyethylene glycol esters of fatty acids, such as polyethylene glycol stearate; block copolymers of ethylene oxide and propylene oxide; salts of mono and dialkyl phosphate esters; vegetable or seed oils such as soybean oil, rapeseed/canola oil, olive oil, castor oil, sunflower seed oil, coconut oil, corn oil, cottonseed oil, linseed oil, palm oil, peanut oil, safflower oil, sesame oil, tung oil and the like; and esters of the above vegetable oils, particularly methyl esters.

Oftentimes, some of these materials, such as vegetable or seed oils and their esters, can be used interchangeably as an agricultural adjuvant, as a liquid carrier or as a surface active agent.

Other additives commonly used in agricultural compositions include compatibilizing agents, antifoam agents, sequestering agents, neutralizing agents and buffers, corrosion inhibitors, dyes, odorants, spreading agents, penetration aids, sticking agents, dispersing agents, thickening agents, freezing point depressants, antimicrobial agents, and the like.

The compositions may also contain other compatible components, for example, other herbicides, plant growth regulators, fungicides, insecticides, and the like and can be formulated with liquid fertilizers or solid, particulate fertilizer carriers such as ammonium nitrate, urea and the like.

The concentration of the active ingredients in the composition of the present invention is generally from 0.001 to 98 percent by weight. Concentrations from 0.01 to 90 percent by weight are often employed. In compositions designed to be employed as concentrates, the active ingredients are generally present in a concentration from 1 to 98 weight percent, preferably 10 to 90 weight percent. Such compositions are typically diluted with an inert carrier, such as water, before application. The diluted compositions usually applied pre-emergence to weeds or the locus of weeds generally contain 0.0001 to 10 weight percent active ingredient and preferably contain 0.001 to 5.0 weight percent.

The present compositions can be applied to weeds or their locus by the use of conventional ground or aerial dusters, sprayers, and granule applicators, and by other conventional means known to those skilled in the art. Preferably the composition is applied by directed

The mixture of this invention can be formulated in a number of ways:
i. diuron (formula I) and oxyfluorfen (formula II) can be formulated into separate herbicidal compositions and applied separately or applied simultaneously (e.g., as a tank mix) in an appropriate weight ratio; or
ii. diuron (formula I) and oxyfluorfen (formula II) can be formulated together in the desired weight ratio in a single herbicidal composition.

In a preferred embodiment, diuron and oxyfluorfen are formulated together in a single herbicidal composition. Preferably diuron and oxyfluorfen are present as 400+40, 500+50, 600+60, 700+70, 800+80, 900+90 g/L diuron and oxyfluorfen respectively.

Also provided herein are methods of controlling undesirable vegetation comprising contacting the vegetation or the locus thereof (i.e. area adjacent to the vegetation) with, or applying to the soil or water to prevent the emergence or growth of vegetation, a herbicidally effective amount of (a) diuron and (b) oxyfluorfen.

In one embodiment, provided herein are methods of controlling undesirable vegetation comprising contacting the vegetation or the locus thereof (i.e. area adjacent to the vegetation) with, or applying to the soil or water to prevent the emergence or growth of vegetation, a herbicidally effective amount of (a) diuron and (b) oxyfluorfen, wherein the weight ratio of diuron to oxyfluorfen is within the range of from 3:1 to 15:1. Preferably the weight ratio of diuron to oxyfluorfen is from 4:1 to 12:1, more preferably 5:1 to 10:1. Most preferably the weight ratio diuron to oxyfluorfen is 10:1.

In some embodiments, diuron and oxyfluorfen are formulated in one composition, tank mixed, applied simultaneously, or applied sequentially. Preferably, diuron and oxyfluorfen are formulated in one composition. This provides a ready-for-use mix and reduces dosing mistakes.

In some embodiments of the methods described herein, diuron and oxyfluorfen are applied simultaneously, including, e.g., in the form of a composition.

Herbicidal activity is exhibited by the compounds when they are applied directly to the plant or to the locus of the plant at any stage of growth.

The effect observed depends upon the plant species to be controlled, the stage of growth of the plant, the application parameters of dilution and spray drop size, the particle size of solid components, the environmental conditions at the time of use, the specific compound employed, the specific adjuvants and carriers employed, the soil type, and the like, as well as the amount of chemical applied. These and other factors can be adjusted to promote non-selective or selective herbicidal action.

In a preferred embodiment, a pre-emergence control is provided of at least 85% control compared to an untreated check. This level of control is perceived by a farmer as effective. The % control can be assessed by comparison of the biomass produced weed growth on a treated plot versus an untreated plot. The percentage control can be expressed as % reduction, wherein I 85 represents the dose for 85% of weed control and biomass reduction. Preferably, pre-emergence control is 86%, 87%, 88%, 89%, 90%, 91%, 92%, 93%, 94%, 95% and more compared to an untreated check.

In some embodiments, the compositions described herein are applied as a post-emergence application or pre-emergence application to achieve the maximum control of weeds; preferably as pre-emergence application.

In some embodiments, diuron and oxyfluorfen when applied in combination displayed a synergistic effect. As described in the Herbicide Handbook of the Weed Science Society of America, Eighth Edition, 2002, p. 462 “‘synergism’ [is] an interaction of two or more factors such that the effect when combined is greater than the predicted effect based on the response to each factor applied separately.”

For example, it has been surprisingly found that a combination of 900 g diuron/ha and 90 g oxyfluorfen/ha exhibits a synergistic action in the pre-emergence weed control of Sow thistle (Sonchus tenerrimus), fleabane (Conyza bonariensis), black nightshade (Solanum nigrum), wall-rocket (Diplotaxis erucoides), pigweed, redroot (Amaranthus retroflexus).

The invention is further described by the following non-limiting examples which her illustrate the invention, and are not intended to, nor should they be interpreted to, limit the scope of the invention.

### EXAMPLES

### Example 1: Diuron and Oxyfluorfen Compositions

### Suspensions (SC)

In an agitated ball mill, 40-80 wt % diuron and oxyfluorfen active ingredients are comminuted with addition of 2-10 wt % dispersants and wetting agents (e.g. sodium lignosulfonate and alcohol ethoxylate), 0.1-2 wt % thickener (e.g. xanthan gum) and ad water ad 100 wt % to give a fine active ingredient suspension. Dilution with water gives a stable suspension of the active ingredients.

### Water-Dispersible Granules and Water-Soluble Granules (WG, SG)

40-80 wt % diuron and oxyfluorfen active ingredients are ground finely with addition of dispersants and wetting agents (e.g. sodium lignosulfonate and alcohol ethoxylate) ad 100 wt % and prepared as water-dispersible or water-soluble granules by means of technical appliances (e. g. extrusion, spray tower, fluidized bed). Dilution with water gives a stable dispersion or solution of the active ingredient.

### Water-Dispersible Powders and Water-Soluble Powders (WP, SP, WS)

40-80 wt % diuron and oxyfluorfen active ingredients are ground in a rotor-stator mill with addition of 1-5 wt % dispersants (e.g. sodium lignosulfonate), 1-3 wt % wetting agents (e.g. alcohol ethoxylate) and solid carrier (e.g. silica gel) ad 100 wt %. Dilution with water gives a stable dispersion or solution of the active ingredient.

### Example 2: Evaluation of Herbicidal Activity in Olives, Citrus and Vines

Field trials were conducted in agricultural crops using standard herbicide small plot research methodology. Plots varied from 12 square meters (m²) to 30 m² (2×15) with 3 to 4 replicates per treatment. The citrus crops were grown using normal cultural practices for the respective areas for the trials, using normal planting, fertilization, watering, flooding and maintenance for pests to ensure good growth of the crop and the weeds.

All treatments in the field trials were applied with a knapsack sprayer using compressed air as propellant. The sprayer was equipped with a boom and flat fan nozzles, and calibrated to apply homogeneously a spray volume of 200 to 400 litres/hectare at constant pressure.

Commercially available products of diuron (Diuron 800 SC) and oxyfluorfen (Oxyfluorfen 480 SC) were mixed in water at appropriate formulated product rates to achieve the desired rates shown based on a unit area of application (hectare).

Treatments were rated at different intervals from treatment to evaluation, from 15 to 91 days after application as compared to the untreated control plants. Assessment were done recording the percentage of ground covered by weeds and the visual efficacy on a scale of 0 to 100 percent where 0 corresponds to no weed control and 100 corresponds to complete weed control.

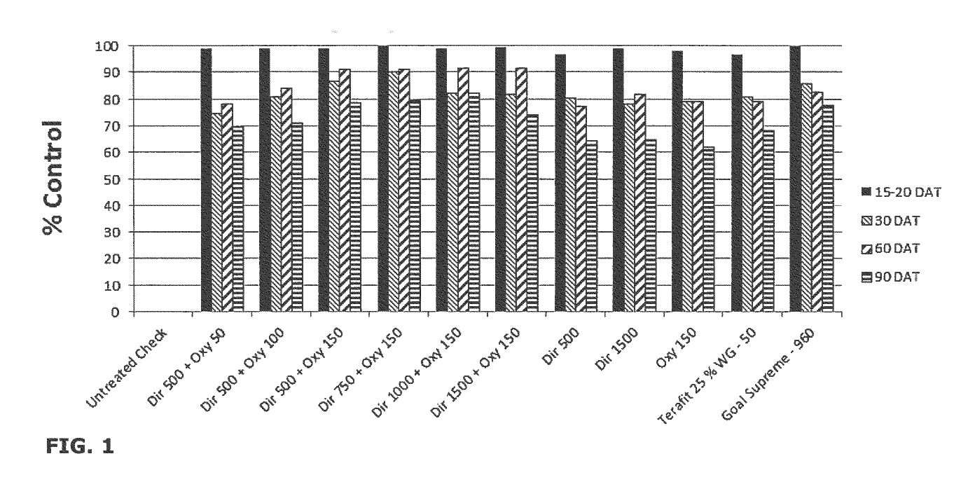

FIG. 1 provides a schematic summary of five trials conducted in Spain on vines, olives and citrus. It reports the effects observed on the perennial broadleaf weed Convolvulus arvensis.

From the results it can be seen that Diuron at 1000 g/ha in combination with Oxyfluorfen at 150 g ai/ha was the best combination tested, followed by Diuron 750 g ai/ha+Oxyfluorfen 150 g ai/ha and Diuron 500 g ai/ha+Oxyfluorfen 150 g ai/ha. Compared to Diuron 1500 g/ha, Diuron 500 g ai/ha and Oxyfluorfen 150 g/ha, these combinations provide a more efficacious and longer lasting control. Also the combination of 1500 g ai/ha Diuron and 150 g/ha Oxyfluorfen provided a more effective control at Day 90 compared to the single product applications.

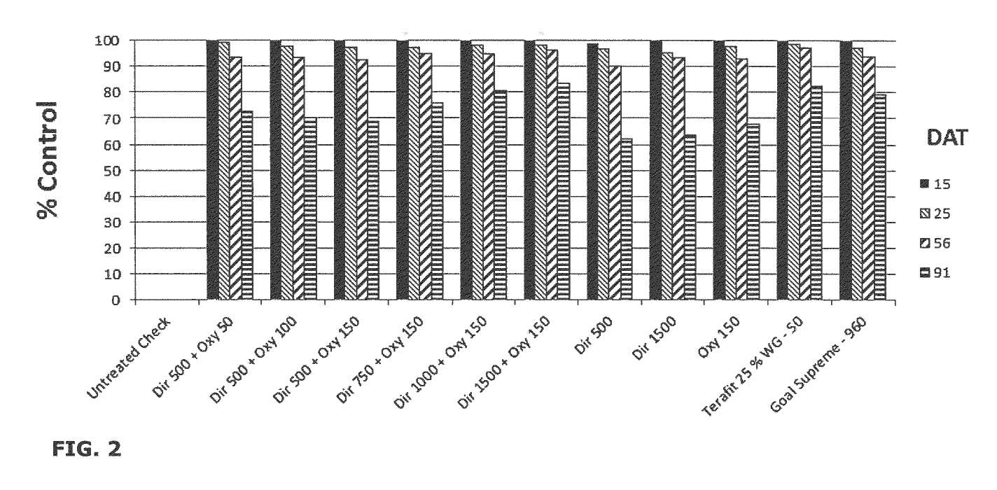

FIG. 2 provides a schematic summary of three trials conducted in Spain on vines, olives and citrus. It reports the effects observed on the perennial broadleaf weed Sonchus tenerrimus.

From the results it can be seen that that Diuron at 1500 g/ha in combination with Oxyfluorfen 150 g/ha was the best combination tested, followed by Diuron at 1000 g/ha in combination with Oxyfluorfen at 150 g ai/ha, followed by Diuron 750 g ai/ha+Oxyfluorfen 150 g ai/ha. Compared to Diuron 1500 g/ha, Diuron 500 g ai/ha and Oxyfluorfen 150 g/ha, it is clear that these combinations provided a more efficacious and longer lasting control.

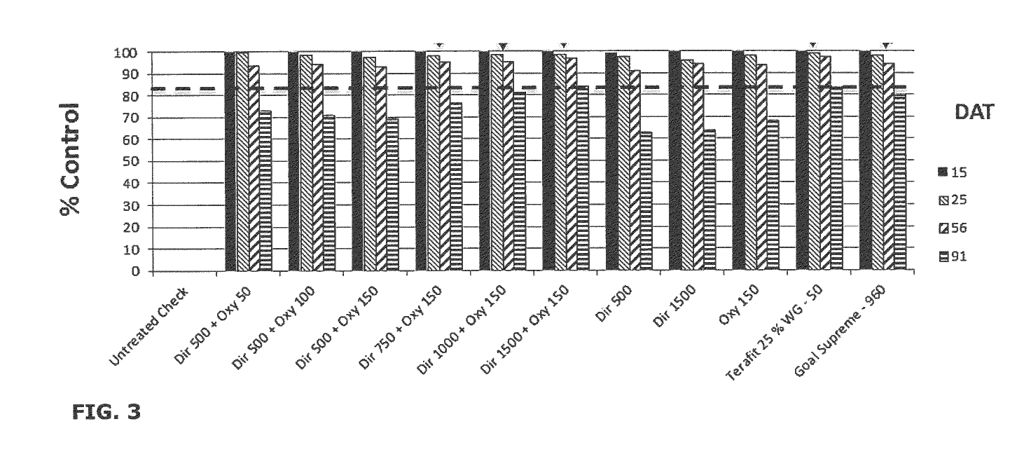

FIG. 3 provides a schematic summary of six trials conducted in Spain on vines, olives and citrus. It reports the effects observed on fifteen annual and biennial broadleaf weeds.

From the results it can be seen that that Diuron at 1500 g/ha in combination with Oxyfluorfen 150 g/ha was the best combination tested. It provided 85% control up to 91 days after treatment. This control level is perceived by a farmer as excellent. This product combination is followed in performance by Diuron at 1000 g/ha in combination with Oxyfluorfen at 150 g ai/ha, followed by Diuron 750 g ai/ha+Oxyfluorfen 150 g ai/ha. Compared to Diuron 1500 g/ha, Diuron 500 g ai/ha and Oxyfluorfen 150 g/ha, it is clear that these combinations provided a more efficacious (higher % control) and longer lasting control (DAT 91).

### Example 3: Evaluation of Pre-Emergence Herbicidal Activity of Mixtures in Citrus

Field trials were conducted in citrus crops using standard herbicide small plot research methodology. Plots varied from 12 square meters (m²) to 30 m² (2×15) with 3 to 4 replicates per treatment. The citrus crops were grown using normal cultural practices for the respective areas for the trials, using normal planting, fertilization, watering, flooding and maintenance for pests to ensure good growth of the crop and the weeds.

All treatments in the field trials were applied with a knapsack sprayer using compressed air as propellant. The sprayer was equipped with a boom and flat fan nozzles, and calibrated to apply homogeneously a spray volume of 200 to 400 litres/hectare at constant pressure.

Diuron in combination with oxyfluorfen, in the form of a ready for use formulation, was compared to a diuron formulation and an oxyfluorfen formulation, at dose rates of respectively 990 g/a.i., 900 g a.i./ha and 90 g a.i./ha.

Treatments were rated at different intervals from treatment to evaluation, from 15 to 120 days after application as compared to the untreated control plants. Assessment were done recording the percentage of ground covered by weeds and the visual efficacy on a scale of 0 to 100 percent where 0 corresponds to no weed control and 100 corresponds to complete weed control.

Tables 1 to 3 demonstrate the synergistic herbicidal efficacy of the diuron+oxyfluorfen combination for pre-emergence residual weed control.

Trials were conducted under field conditions in Spain. Trial sites were located in commercially grown European citrus crop. The citrus trees were grown using normal cultural practices for fertilization, seeding and maintenance to ensure good growth of the crop and the weeds. The trials were conducted using normal research methodology. Plots varied from 12 square meters (m²) to 30 m² (2×15) with 3 to 4 replicates per treatment. All treatment results are an average of 3 to 4 replicates. The trials had naturally occurring populations of weeds. The weed spectrum included, but was not limited to black nightshade (Solanum nigrum; SOLNI), Sow thistle (Sonchus tenerrimus, SONTE), fleabane (Conyza bonariensis, ERIBO), DIPER, hairy fleabane (Conyza bonariensis, ERIBO), redroot pigweed (Amaranthus retroflexus, AMA).

Treatments consisted applications of diuron+oxyfluorfen, diuron solo or oxyfluorfen solo. The combination product application demonstrates a positive, synergistic interaction according to Colby's equation. Colby's equation was used to determine the herbicidal effects expected from the mixtures (Colby, S. R. Calculation of the synergistic and antagonistic response of herbicide combinations. Weeds 1967, 15, 20-22.). The following equation was used to calculate the expected activity of mixtures containing two active ingredients, A and B:

Expected=A+B−(A×B/100)

A=observed efficacy of active ingredient A at the s e concentration as used in the mixture. B=observed efficacy of active ingredient B at the s e concentration as used in the mixture.

Some of the compounds tested, application rates employed, plant species tested, and results are given in Tables 1 to 3. Ob=Observed visual weed control, Ex=Expected weed control as defined by Colby Equation

### Citrus Trials

TABLE 1
Synergistic Herbicidal Activity from pre-emergence
applications on residual broadleaf weed
control in the field when rated
15 to 90 Days after application
(SRES14 059 230 HE).
% Control

| Application Rate | | | | | | | |
|---|---|---|---|---|---|---|---|
| (g a.i./ha) | | SONTE | | ERIBO | | SOLNI | |
| Diuron | Oxyfluorfen | Obs | Exp | Obs | Exp | Obs | Exp |
| 900 | 0 | 57.5 | — | 62.5 | — | 55 | — |
| 0 | 90 | 28.8 | — | 35 | — | 47.5 | — |
| 900 | 90 | 75 | 70 | 85 | 76 | 85 | 76 |

SONTE = Sow thistle (Sonchus tenerrimus)
ERIBO = fleabane (Conyza bonariensis)
SOLNI = black nightshade (Solanum nigrum)

TABLE 2
Synergistic Herbicidal Activity from pre-emergence applications on
residual broadleaf weed control in the field when rated 15 to 90
Days after application (SRES14 060 230 HE).
% Control

| Application Rate | | | | | |
|---|---|---|---|---|---|
| (g a.i./ha) | | SONTE | | ERIBO | |
| Diuron | Oxyfluorfen | Obs | Exp | Obs | Exp |
| 900 | 0 | 45 | | 46.3 | |
| 0 | 90 | 10 | | 47.5 | |
| 900 | 90 | 80 | 51 | 72.5 | 71.8 |

SONTE = sow thistle (Sonchus tenerrimus)
ERIBO = hairy fleabane (Conyza bonariensis)

TABLE 3
Synergistic Herbicidal Activity from pre-
emergence applications on residual broadleaf
weed control in the field when rated
15 to 90 Days after application
(SRES14 061 230 HE).
% Control

| Application Rate | | | | | | | |
|---|---|---|---|---|---|---|---|
| (g a.i./ha) | | DIPER | | ERIBO | | AMARE | |
| Diuron | Oxyfluorfen | Obs | Exp | Obs | Exp | Obs | Exp |
| 900 | 0 | 88.8 | | 28.8 | | 53.8 | |
| 0 | 90 | 20 | | 43.8 | | 45 | |
| 900 | 90 | 93.8 | 91 | 78.8 | 60 | 91.3 | 75 |

DIPER = Wall-rocket (Diplotaxis erucoides)
ERIBO = hairy fleabane (Conyza bonariensis)
AMARE = pigweed, redroot (Amaranthus retroflexus)

1. A pre-emergence herbicidal composition for controlling broadleaf weeds and/or annual grasses in agricultural crops comprising a herbicidally effective and herbicidally synergistically effective amount of (a) diuron and (b) oxyfluorfen and an agriculturally acceptable adjuvant and/or carrier.

2. The herbicidal composition according to claim 1, wherein the composition is in the form of a suspension concentrate (SC).

3. The herbicidal composition according to claim 1, wherein the weight ratio of diuron to oxyfluorfen is between 15:1 and 5:1.

4. The herbicidal composition according to claim 3, wherein the composition comprises 400-950 g/L diuron and 40-95 g/L oxyfluorfen.

5. A method of controlling weeds and/or grasses in agricultural crops which comprises contacting the vegetation or the locus thereof with or applying to the soil to prevent the emergence or growth of weeds or grasses a herbicidally effective and herbicidally synergistically effective amount of a herbicidal composition according to claim 1.

6. The method of claim 5, wherein the agricultural crops are perennial tree crops or vine crops at least four years of age.

7. The method according to claim 5, wherein the herbicidal composition is applied at an application rate of 440 g/ha to 1500 g/ha based on the total amount of active ingredients diuron and oxyfluorfen in the composition.

8. Method according to claim 7, wherein the applicative dose of diuron is within the range of 400-950 g per hectare and the applicative dose of oxyfluorfen is within the range of 40-95 g per hectare.

9. Method according to claim 8, wherein per hectare one third of the area is treated.

10. The method according to claim 5, wherein the components of the mixture are applied either separately or as part of a multipart herbicidal system, which can be provided as a premix or a tank mix.

11. The method according to claim 5, wherein the weeds are selected from Convolvulus arvensis, Sonchus tennerimus, Malva sylvestris, Anagalis arvensis, Anthemis arvensis, Diplotaxis erucoïdes, Papaver rhoeas, Chenopodium album, Fumaria officinalis, Conyza bonariensis, Erigeron canadensis, Amaranthus species, Senecio vulgaris, Lamium amplexicaule, Heliotropium europaeum, Urtica urens, Rumex spinosus, Calendula arvensis, Portulaca oleracea, Sorghum halepense, Cyperus rotundus, Lolium multiflorum, Poa annua, and combinations thereof.

12. The method according to claim 5, wherein the agricultural crop is selected from olive trees, citrus trees, vines, pome fruit trees and stone fruits.

13. (canceled)

14. The method according to claim 5, wherein the pre-emergence control provides at least 85% control compared to an untreated check.
